(19) United States
(12) Patent Application Publication
(10) Pub. No.: US 2023/0202618 A1
(43) Pub. Date: Jun. 29, 2023

(54) DRIVE UNIT AND COVER OF DRIVE UNIT

(71) Applicant: YAMAHA HATSUDOKI KABUSHIKI KAISHA, Iwata-shi (JP)

(72) Inventor: Masayuki AKASAKA, Shizuoka (JP)

(21) Appl. No.: 18/084,600

(22) Filed: Dec. 20, 2022

(30) Foreign Application Priority Data
Dec. 24, 2021 (JP) 2021-210310

(51) Int. Cl. B62M 6/55

(52) U.S. Cl. CPC B62M 6/55

(57) ABSTRACT

A drive unit includes a motor, a housing mountable on a vehicle to hold the motor, and a cover including a bottom portion to cover at least a portion of a lower surface of the housing, and a left side wall extending from the bottom portion and covering at least a portion of the left side of the housing. The cover includes a first hole located in at least one of (a) a location on the bottom portion to the left of a center of the bottom portion in a left-right direction of the vehicle, or (b) the left side wall. When the vehicle with the housing mounted thereon tilts to the left from an upright position by 5°, at least a portion of an interior edge of the cover at the first hole is at a lowest location on an inner surface of the cover in a direction of gravity.

### CROSS-REFERENCE TO RELATED APPLICATION

This application is based upon and claims the benefit of priority to Japanese Patent Application No. 2021-210310, filed on Dec. 24, 2021, the entire contents of which are hereby incorporated herein by reference.

### BACKGROUND OF THE INVENTION

### 1. Field of the Invention

The present invention relates to a drive unit mountable on a vehicle, and a cover thereof.

### 2. Description of the Related Art

Vehicles such as electric motor-assisted bicycles include a drive unit mounted thereon wherein the drive unit has a motor. A drive unit includes a housing constructed to be mountable on a vehicle, and a motor contained in the housing. JP 2021-035110 A describes a drive unit including a housing, a motor, and a cover. The cover is constructed to cover at least some portions of the housing and motor. Portions of the cover that cover at least some portions of the housing and motor include a through-hole. The through-hole is a slit with a width of 10 mm or less, or has a maximum width of 10 mm or less.

### SUMMARY OF THE INVENTION

The inventors of preferred embodiments of the present invention discovered that, when a vehicle is parked, water may accumulate inside the cover of the drive unit. Conventional drive units are not designed to effectively let out water inside the cover.

A drive unit for a vehicle according to a preferred embodiment of the present invention includes a motor, a housing mountable on the vehicle to hold the motor, and a cover to cover at least a portion of the housing. The cover includes a bottom portion to cover at least a portion of a lower surface of the housing, and a left side wall extending from the bottom portion to cover at least a portion of a left side of the housing in a left-right direction of the vehicle. The cover includes a first hole located in at least one of (a) a location on the bottom portion to the left of a center of the bottom portion in the left-right direction, or (b) the left side wall. As used herein, “a first hole located in at least one of (a) a location on the bottom portion to the left of a center of the bottom portion in the left-right direction, or (b) the left side wall” can mean a first hole present only in the above-specified location on the bottom portion, a first hole present only in the left side wall, or a first hole present in both the above-specified location on the bottom portion and the left side wall. When the vehicle with the housing mounted thereon tilts to the left from an upright position by 5°, at least a portion of an interior edge of the cover at the first hole is at a lowest location on an inner surface of the cover in a direction of gravity.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view of an exemplary vehicle with a drive unit according to a preferred embodiment of the present invention mounted thereon.

FIG. 2 is an enlarged view of the drive unit shown in FIG. 1.

FIG. 3 is a right side view of the cover shown in FIG. 2.

FIG. 4 is a cross-sectional view of the drive unit taken along line A-A of FIG. 2.

FIG. 5 is a left side view of an exemplary drive unit attached to a vehicle body frame at an angle different from that in FIG. 2.

FIG. 6 is a left side view of an exemplary drive unit attached to the vehicle body frame at an angle different from that in FIG. 2.

FIG. 7 is a bottom view of the cover of the drive unit shown in FIG. 2.

FIG. 8 is a top view of the cover of the drive unit shown in FIG. 2.

FIG. 9 is a cross-sectional view of a variation of the cover shown in FIG. 4.

FIG. 10 is a cross-sectional view of another variation of the cover shown in FIG. 4.

### DETAILED DESCRIPTION OF THE PREFERRED EMBODIMENTS

In the present description, the directions “front/forward” and “rear(ward)”, “left” and “right”, and “top/up(ward)” and “bottom/down(ward)” with respect to the drive unit and cover refer to such directions with respect to the vehicle when the housing is mounted on the vehicle and the vehicle is in its upright position, unless specifically stated otherwise. The upright position of the vehicle refers to the vehicle's axis in the top-bottom direction of the vehicle body (i.e., vehicle body frame) that corresponds to a vertical direction (i.e., direction of gravity). The top-bottom direction and front-rear direction of the drive unit and cover when not mounted on the vehicle need not be determined exactly and uniquely. For example, for the drive unit and cover when not mounted on the vehicle, the top-bottom direction and front-rear direction may be any direction within ranges that result in the top-bottom direction and front-rear direction when the unit and cover are mounted on the vehicle.

In cases where a drive unit mounted on the vehicle is provided with a cover, liquid such as water often enters the space between the cover and drive unit. To let out water that has entered the space between the cover and drive unit, a hole is provided at the lowest location on the cover to let the water out therethrough. However, the water may remain on the inner surface of the cover despite the presence of a hole intended to let the water out. The inventors of preferred embodiments of the present invention discovered that, when the vehicle is parked, the tilt of the drive unit is slightly different from that when the vehicle is traveling such that water is not easily let out through the hole from inside the cover. For example, when the vehicle is parked, it is often tilted to the left, rather than being in the upright position. As such, water may not be let out through the hole and thus remains inside the cover. On the other hand, while the vehicle is traveling, water that has entered the cover of the drive unit is able to be let out through the hole of the cover due to movement of the vehicle. Based on these findings, the inventors of preferred embodiments of the present invention examined various arrangements of the cover to let out the water more effectively, and developed the preferred embodiments of the present invention described below.

A drive unit for a vehicle according to a preferred embodiment of the present invention includes a motor, a housing mountable on the vehicle to hold the motor, and a cover to cover at least a portion of the housing. The cover includes a bottom portion to cover at least a portion of a lower surface of the housing, and a left side wall extending from the bottom portion to cover at least a portion of a left side of the housing in a left-right direction of the vehicle. The cover includes a first hole located in at least one of (a) a location on the bottom portion to the left of a center of the bottom portion in the left-right direction, or (b) the left side wall. When the vehicle with the housing mounted thereon tilts to the left from an upright position by 5°, at least a portion of an interior edge of the cover at the first hole is at a lowest location on an inner surface of the cover in a direction of gravity.

In the above-described arrangement, when the vehicle with the housing mounted thereon tilts to the left from the upright position by 5°, at least a portion of the interior edge of the first hole is not higher than any location on the inner surface of the cover in the direction of gravity. That is, when the vehicle is parked, as it tilts to the left from the upright position, at least a portion of the interior edge of the cover at the first hole is at the lowest location on the inner surface of the cover in the direction of gravity. Thus, water inside the cover is able to easily be let out when the vehicle is parked. Further, the first hole is provided at a location that, when the vehicle is traveling, allows water to be easily let out through the first hole due to movement of the vehicle. This achieves a drive unit that is able to effectively let out water inside the cover.

In the above-described arrangement, in a cross section represented by a plane extending in the left-right direction of the vehicle and extending through the first hole, at least a portion of the interior edge of the cover at the first hole is at the lowest location on the inner surface of the cover in the direction of a reference axis extending obliquely downward to the left at an angle of 5° from the top-bottom direction of the vehicle. The interior edge of the cover at the first hole refers to the edge of the first hole which is in contact with the inner surface of the cover.

It is preferable that, when the vehicle with the housing mounted thereon tilts to the left from the upright position by 5°, the inner surface of the cover has no portion that is higher in the direction of gravity as it extends toward the interior edge of the first hole. That is, it is preferable that, when the housing tilts to the left by 5°, a location on the entire inner surface of the cover is lower than or remains at the same height in the direction of gravity as it extends toward the interior edge of the first hole. Thus, when the vehicle tilts to the left by 5°, water on the inner surface of the cover is able to easily flow toward the first hole due to gravity.

When the vehicle with the housing mounted thereon is in the upright position, the bottom portion of the cover may be shaped to protrude downwardly as viewed from the left in the left-right direction. For example, as viewed in the left-right direction of the vehicle, the bottom portion of the cover may be shaped such that an intermediate portion between a front portion and a rear portion in the front-rear direction of the vehicle is located lower than the front and rear portions. In such implementations, the first hole may be located, as viewed from the left, between the front and rear portions (i.e., in the intermediate portion) of the bottom portion or at a location on the left side wall above the intermediate portion of the bottom portion.

The first hole may be located, as viewed from the left in the left-right direction of the vehicle, at a location overlapping an imaginary line extending through a region of the inner surface of the cover, that is the lowest location thereon when the vehicle with the housing mounted thereon is in the upright position, and extending upward in the top-bottom direction of the vehicle (i.e., line A). Thus, water on the inner surface of the cover is able to easily flow to the first hole due to gravity.

The first hole may extend to a ridge between the bottom portion and the left side wall of the cover. Thus, water is able to easily exit through the first hole when the vehicle tilts toward the left. For example, the first hole may be provided in at least one of a portion of the bottom portion that extends to the ridge between the bottom portion and left side wall, or a portion of the left side wall.

When the vehicle with the housing mounted thereon is in the upright position, the first hole may be located such that a portion of the interior edge of the first hole is at a lowest location on the inner surface of the cover. Thus, water is able to easily exit through the first hole regardless of whether the vehicle is in the upright position or tilts toward the left.

When the vehicle with the housing mounted thereon is in the upright position, a lowermost point of the interior edge of the first hole may be located lower than the housing. Thus, there is a space between the housing and a portion of the cover that includes the first hole to allow water to pass therethrough. For example, a space may be provided between the cover and housing below the housing and the first hole may be provided to connect to this space.

The distance between the housing and the interior edge of the cover at the first hole is preferably not smaller than 5 mm, and more preferably not smaller than about 10 mm, for example. Providing a clearance between the housing and first hole provides a passageway for water to reach the first hole such that water is able to easily flow to the first hole.

It is preferable that the maximum width of the first hole is not smaller than 5 mm, for example. This makes it less likely that water remains therein to block the first hole due to surface tension. Thus, water is able to easily exit through the first hole. The maximum width is defined as the width in the direction in which the dimension of the opening defined by the first hole is at its largest.

The dimension of the first hole in the front-rear direction may be larger than at least one of the dimension in the top-bottom direction or the dimension in the left-right direction. Providing such a first hole elongated in the front-rear direction provides a passageway for water over a wide range along the front-rear direction.

The cover may have a protruding shape protruding toward the bottom of the vehicle as viewed in the left-right direction of the vehicle. In such implementations, the first hole may be located, in side view, at an apex of the protruding shape of the bottom portion or a location on the left side wall corresponding to the apex.

The left-right direction of the vehicle may be the same as the direction of the axis of the motor held by the housing. In some implementations, the housing may include an attachment portion (i.e., boss) including a bolt hole to mount the housing on the vehicle. The left-right direction may be the same as the axial direction of the bolt hole of the attachment portion (i.e., boss) of the housing.

The bottom portion of the cover may be an integral, plate-shaped lower cover (i.e., undercover) located below the housing and extending from the left to the right. Alternatively, the cover may include a left cover to cover the left of the housing, and a right cover to cover the right of the housing, the right cover being in contact with the left cover at a location below the housing. In such implementations, the bottom portion of the cover may be defined by a lower portion of the left cover and a lower portion of the right cover.

A rib may be provided on the bottom portion of the cover to extend upward from the inner surface. Thus, when an upward thrust is applied to the cover from below, the rib prevents deformation of the cover. This improves the impact resistance of the cover.

The first hole may be provided in the left side wall. In such implementations, as viewed from the left in the left-right direction of the vehicle, at least a portion of the first hole may be located below the housing and not overlap the housing. This provides a space between the housing and cover to temporarily hold water, thus allowing water to exit the housing.

The cover may include a right side wall extending from the bottom portion to cover at least a portion of a right side of the housing in the left-right direction of the vehicle. The cover may include a second hole provided in at least one of (c) a location on the bottom portion to the right of the center of the bottom portion in the left-right direction of the vehicle, or (d) the right side wall. The second hole may be provided such that, when the vehicle with the housing mounted thereon tilts to the right from the upright position by 5°, at least a portion of an interior edge of the cover at the second hole is at a lowest location on the inner surface of the cover in the direction of gravity. Thus, water is able to be effectively let out from inside the cover regardless of whether the vehicle tilts to the left or right when parked.

The first hole may be provided in the left side wall. The second hole may be provided in the right side wall. As viewed in the left-right direction, at least a portion of the first hole may overlap at least a portion of the second hole. Thus, air is able to flow into the cover in the left-right direction more easily. Thus, water is able to be let out from inside the cover more easily.

An edge of the first hole as viewed in the left-right direction of the vehicle may include a line extending obliquely downward from a front toward a rear. As an edge of the first hole is thus inclined, moving air is able to help water inside the cover to be efficiently let out while the vehicle is traveling. For the same purpose, an edge of the second hole as viewed in the left-right direction of the vehicle may include a line extending obliquely downward from the front toward the rear.

When the vehicle with the housing mounted thereon is in the upright position, the interior edge of the cover at the first hole may be inclined toward the left in the left-right direction of the vehicle. That is, the leftmost point of the edge of the first hole may be located higher than the rightmost point thereof. Thus, water that has flowed along the inner surface of the cover from above the first hole is able to be let out through the first hole more easily.

In some implementations, when the vehicle with the housing mounted thereon is in the upright position, the interior edge of the cover of the first hole may be inclined toward the right in the left-right direction of the vehicle. In such implementations, the lowermost point of the edge of the first hole is located farther toward the left (i.e., outward) than the uppermost point thereof. Thus, water drops and/or mud splashed from below while the vehicle is traveling is less likely to enter the interior of the cover through the first hole.

When the vehicle with the housing mounted thereon is in the upright position, the interior edge of the second hole may be inclined toward the right in the left-right direction of the vehicle. That is, the rightmost point of the edge of the second hole may be located higher than the leftmost point thereof. Thus, water that has flowed along the inner surface of the cover from above the second hole is able to be let out through the second hole more easily. In some implementations, when the vehicle with the housing mounted thereon is in the upright position, the interior edge of the cover of the second hole may be inclined toward the left along the left-right direction of the vehicle.

The left side wall may extend from the interior edge of the cover at the first hole upwardly and outwardly in the left-right direction of the vehicle. Thus, portions of the left side wall located above the first hole are shaped to better conform with the shape of the housing.

The left side wall may extend from the interior edge of the cover at the first hole upwardly and inwardly in the left-right direction of the vehicle. Thus, the first hole is less visible obliquely from above on the side. Further, as portions of the left side wall located above the first hole expand outwardly as the first hole extends downward, air inside the cover is able to easily be let out through the first hole.

A cover for a drive unit according to a preferred embodiment of the present invention includes a housing mountable on a vehicle to hold a motor. The cover includes a bottom portion to cover at least a portion of a lower surface of the housing, a left side wall extending from the bottom portion to cover at least a portion of a left side of the housing in a left-right direction of the vehicle, and a first hole located in at least one of (a) a location on the bottom portion to the left of a center of the bottom portion in the left-right direction of the vehicle, or (b) the left side wall. In a cross section represented by a plane extending in the left-right direction of the vehicle and extending through the first hole, at least a portion of an interior edge of the cover at the first hole is at a lowest location on an inner surface of the cover in a direction of a reference axis extending obliquely downward to the left at an angle of 5° from a top-bottom direction of the vehicle.

Now, a bicycle according to a preferred embodiment of the present invention will be described with reference to the drawings. In the drawings, the same or corresponding elements are labeled with the same reference numerals, and their description will not be repeated. Further, the sizes of the components in the drawings do not exactly represent the sizes of the actual components, the size ratios between the components, or the like. In the description provided below, the directions “front/forward” and “rear(ward)”, “left” and “right”, and “top/up(ward)” and “bottom/down(ward)” with respect to the vehicle refer to such directions as perceived by a rider on the vehicle. The directions “front/forward” and “rear(ward)”, “left” and “right”, and “top/up(ward)” and “bottom/down(ward)” with respect to the vehicle are the same as such directions with respect to the vehicle body frame of the vehicle and the drive unit mounted on the vehicle. Furthermore, the direction of advance of the vehicle is the same as the front-rear direction of the vehicle. “F”, “B”, U″, “D”, “R”, and “L” in the drawings mean forward, rearward, upward, downward, right and left, respectively.

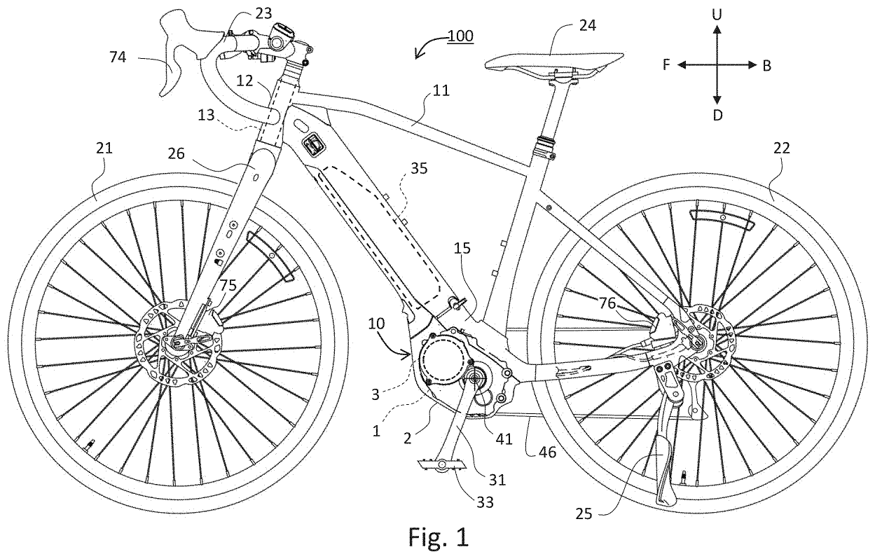

FIG. 1 is a left side view of an exemplary vehicle with a drive unit according to a preferred embodiment of the present invention mounted thereon. FIG. 1 shows a vehicle 100 in its upright position. The vehicle 100 shown in FIG. 1 is, for example, an electric motor-assisted bicycle.

In FIG. 1, the vehicle 100 includes a vehicle body frame 11. The vehicle body frame 11 extends in the front-rear direction. The vehicle body frame 11 includes a head pipe 12 located toward the front. The head pipe 12 rotatably supports a steering shaft 13. Handlebars 23 are attached to the top of the steering shaft 13, and a front fork 26 is attached to the bottom of the shaft. The front fork 26 rotatably supports a front wheel 21 at its lower end. A rear portion of the vehicle body frame 11 rotatably supports a rear wheel 22. A seat 24 is attached to an upper portion of the vehicle body frame 11. The vehicle body frame 11 rotatably supports a crankshaft 41 located toward the bottom thereof. Brake levers 74 are attached to locations on the handlebars 23 toward the left and right. The left brake lever 74 is used to operate a brake 76 for the rear wheel 22. The right brake lever 74 is used to operate a brake 75 for the front wheel 21.

In the implementation shown in FIG. 1, a drive unit 10 is attached to a lower portion of the vehicle body frame 11. The crankshaft 41 is rotatably attached to the drive unit 10. In the present implementation, the crankshaft 41 is rotatably supported by the vehicle body frame 11 with the drive unit 10 located therebetween. The drive unit 10 is attached to a bracket 15 of the vehicle body frame 11, for example. The bracket 15 is located at the lowermost point of the vehicle body frame 11 (in the present implementation, on the seat frame portion and down frame portion). The drive unit 10, as attached to the vehicle body frame 11, is suspended therefrom.

The drive unit 40 includes a motor 3, a housing 1 to hold the motor 3, and a cover 2. The housing 1 is mountable on the vehicle 100. The housing 1 includes an attachment portion (i.e., boss) including a bolt hole extending therethrough in the left-right direction of the vehicle. The bolt extending through the attachment portion of the housing 1 is tightened on the bracket 15 of the vehicle body frame 15. Thus, the housing 1 is attached to the vehicle body frame 11.

The crankshaft 41 extends in the left-right direction of the bicycle. Crank arms 31 are attached to the respective ends of the crankshaft 41. Pedals 33 are attached to the distal ends of the respective crank arms 31. Although not shown, the bicycle 100 is provided with a driving sprocket that rotates together with the crankshaft 41 and a driven sprocket that rotates together with the rear wheel 22. A chain 46 is wound around the driving and driven sprockets to connect them. It will be understood that the chain 46 may be replaced by a belt. The driving sprocket, chain 46, and driven sprocket are examples of transmission members that transmit rotation of the pedals to the rear wheel. The transmission members are not limited to these examples. For example, the sprockets and chain may be replaced with gears and shafts. Further, the transmission members may include a one-way clutch. The one-way clutch transmits forward rotation, and does not transmit rearward rotation.

The vehicle (i.e., bicycle) 100 includes a stand 25 attached to the vehicle body frame 11. When the vehicle 100 (i.e., bicycle) is parked, the stand 25 supports the vehicle 100 such that the vehicle 100 does not overturn. In the implementation of FIG. 1, when the vehicle 100 is parked, the vehicle is supported by the stand 25 while tilting to the left. When the vehicle 100 is in the upright position, the stand 25 is not in contact with the ground. In the implementation of FIG. 1, the stand 25 is attached to a chain stay, which is an element of the vehicle body frame 11. Attaching the stand 25 to a chain stay is a non-limiting example, and the stand may be attached to other portions of the vehicle body frame 11.

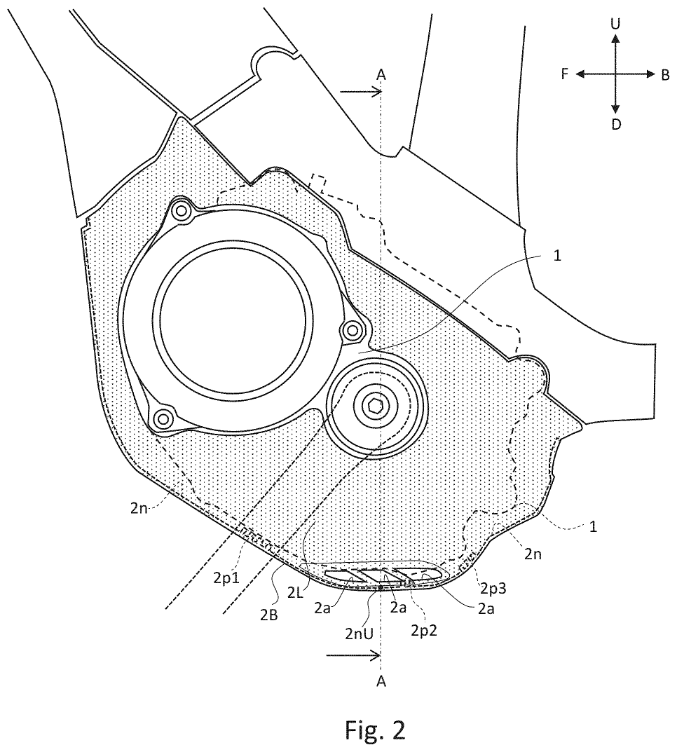

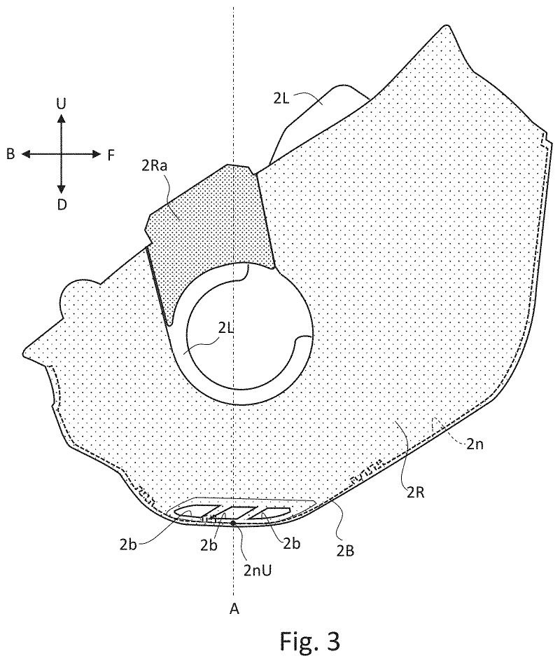

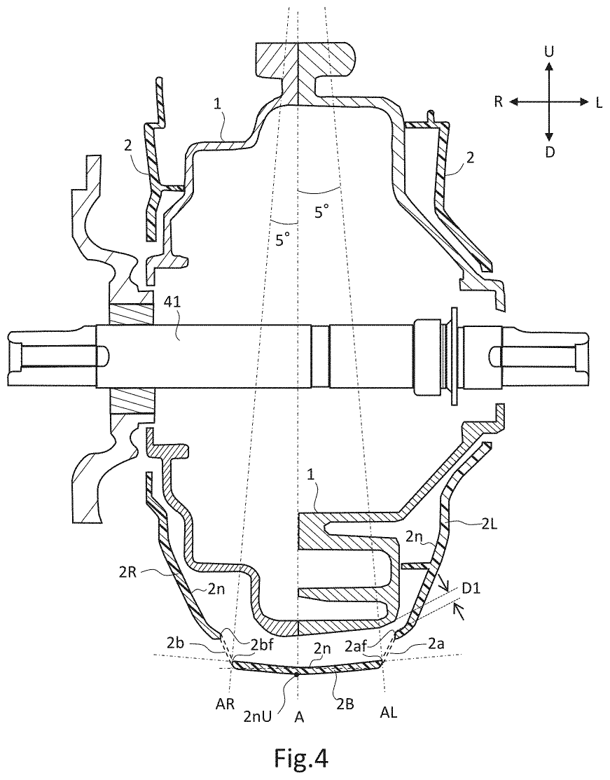

FIG. 2 is an enlarged view of the drive unit 10 shown in FIG. 1. FIG. 3 is a right side view of the cover shown in FIG. 2. FIG. 4 is a cross-sectional view of the drive unit taken along line A-A of FIG. 2. FIGS. 2 to 4 show the drive unit 10, housing 1, and cover 2 as mounted on the vehicle 100 in the upright position. In FIG. 2, the cover 2 is shown as a dotted area for ease of understanding.

As shown in FIG. 2, the cover 2 includes a bottom portion 2B and a left side wall 2L. The bottom portion 2B is located below at least a portion of the lower surface of the housing 1 to cover the lower surface of the housing 1. The left side wall 2L extends upward from the bottom portion 2B and covers at least a portion of the left side of the housing 1.

A first hole 2a is provided in the left side wall 2L of the cover 2. When the vehicle is in the upright position, as viewed from the left in the left-right direction of the vehicle, the first hole 2a is provided at a location that overlaps an imaginary line extending through the lowest location 2nU on the inner surface 2n of the cover 2 and extending in the top-bottom direction. That is, as viewed from the left, the first hole 2a overlaps an imaginary line extending through the lowest location 2nU on the inner surface 2n of the cover 2 and extending upward (i.e., line A).

In the implementation shown in FIG. 2, the bottom portion 2B of the cover 2 is shaped to protrude downward as viewed from the left. An intermediate portion between front and rear portions, in the front-rear direction of the vehicle, of the bottom portion 2B of the cover 2 is located lower than the front and rear portions. That is, a projection is provided between the front and rear ends of the bottom portion 2B of the cover 2 so as to protrude downward from the front and rear ends. As viewed from the left, the first hole 2a is provided at a location on the left side wall above the apex of the projection of the bottom portion 2B.

As shown in FIG. 3, the cover 2 includes a right side wall 2R. In FIG. 3, the right side wall 2R is shown in a dotted line for ease of understanding. The right side wall 2R extends upward from the bottom portion 2B to cover at least a portion of the right side of the housing 1. A second hole 2b is provided in the right side wall 2R. When the vehicle is in the upright position, as viewed from the right in the left-right direction of the vehicle, the second hole 2b is provided at a location that overlaps an imaginary line extending through the lowest location 2nU on the inner surface 2n of the cover 2 and extending in the top-bottom direction. That is, as viewed from the right, the second hole 2b overlaps the imaginary line extending through the lowest location 2nU on the inner surface 2n of the cover 2 and extending upward (i.e., line A). In the implementation shown in FIG. 3, the right side wall 2R includes an opening that allows the crankshaft 41 to extend therethrough. After the cover 2 is mounted on the housing 1, a cover portion 2Ra is inserted above this opening to define a portion of the right side wall 2R.

FIG. 4 shows a cross section represented by a plane extending through the lowest location 2nU on the inner surface 2n of the cover 2 and extending in the left-right direction when the vehicle is in the upright position. In FIG. 4, line AL indicates the direction of gravity when the vehicle 100 with the drive unit 10 (i.e., housing 1) mounted thereon tilts to the left from the upright position by 5°. As shown in FIG. 4, when the vehicle 100 with the housing 1 mounted thereon tilts to the left from the upright position by 5°, at least a portion of the interior edge 2af of the cover at the first hole 2a is at the lowest location on the inner surface 2n of the cover in the direction of gravity. In other words, in a cross section represented by a plane extending in the left-right direction of the vehicle and extending through the first hole 2a, at least a portion of the interior edge 2af of the cover at the first hole 2a is not higher than any location on the inner surface 2n of the cover 2 in the direction of a reference axis (indicated by line AL) extending obliquely downward to the left at an angle of 5° from the top-bottom direction of the vehicle.

In FIG. 4, line AR indicates the direction of gravity when the vehicle 100 with the drive unit 10 (i.e., housing 1) mounted thereon tilts to the right from the upright position by 5°. As shown in FIG. 4, when the vehicle 100 with the housing 1 mounted thereon tilts to the right from the upright position by 5°, at least a portion of the interior edge 2bf of the cover at the second hole 2b is at the lowest location on the inner surface 2n of the cover in the direction of gravity. In other words, in a cross section represented by a plane extending in the left-right direction of the vehicle and extending through the second hole 2b, at least a portion of the interior edge 2bf of the cover at the second hole 2b is not higher than any location on the inner surface 2n of the cover 2 in the direction of a reference axis (indicated by line AR) extending obliquely downward to the right at an angle of 5° from the top-bottom direction of the vehicle (indicated by line A).

In the implementation shown in FIG. 4, the left end of the bottom portion 2B of the cover 2 defines a portion of the edge of the first hole 2a. The inner surface 2n of the bottom portion 2B of the cover 2 is inclined so as to become lower as it extends inwardly from the left end in the left-right direction of the vehicle. In such implementations, the inclination of the inner surface 2n as it extends inwardly from the left end of the bottom portion 2B in the left-right direction may be not more than 5°. Thus, when the vehicle tilts to the left from the upright position by 5°, the edge of the first hole 2a at the left end of the bottom portion 2B is at the lowest location on the inner surface of the bottom portion 2B.

Further, in the implementation shown in FIG. 4, the right end of the bottom portion 2B of the cover 2 defines a portion of the edge of the second hole 2b. The inner surface 2n of the bottom portion 2B of the cover 2 is inclined so as to become lower as it extends inwardly from the right end in the left-right direction of the vehicle. In such implementations, the inclination of the inner surface 2n as it extends inwardly from the right end of the bottom portion 2B in the left-right direction may be not more than 5°, for example. Thus, when the vehicle tilts to the right from the upright position by 5°, the edge of the second hole 2b at the right end of the bottom portion 2B is at the lowest location on the inner surface of the bottom portion 2B.

In the implementation shown in FIG. 4, when the vehicle 100 tilts to the left from the upright position by 5°, the inner surface 2n of the cover includes no portion that is higher in the direction of gravity (i.e., direction of line AL) as it extends toward the interior edge of the first hole 2a. Thus, when the vehicle 100 tilts to the left by 5°, water on the inner surface 2n of the cover is able to easily flow to the first hole 2a.

Further, in the implementation shown in FIG. 4, when the vehicle 100 tilts to the right from the upright position by 5°, the inner surface 2n of the cover includes no portion that is higher in the direction of gravity (i.e., direction of line AR) as it extends toward the interior edge of the second hole 2b. Thus, when the vehicle 100 tilts to the right by 5°, water on the inner surface 2n of the cover is able to easily flow to the second hole 2b.

In the implementation shown in FIG. 4, as viewed in the left-right direction of the vehicle, at least a portion of the first hole 2a overlaps at least a portion of the second hole 2b. A space is provided between the first and second holes 2a and 2b to extend therethrough in the left-right direction of the vehicle. This allows air to flow easily into the cover 2 in the left-right direction.

FIG. 4 shows a cross section represented by a plane extending through the lowest location 2nU on the inner surface 2n of the cover 2 when the vehicle is in the upright position (hereinafter referred to as lowest location 2nU) and extending in the left-right direction of the vehicle. The lowest location 2nU on the inner surface 2n of the cover 2 depends on the angle of the housing 1 relative to the vehicle body frame 11. That is, different angles of the housing 1 relative to the vehicle body frame 11 (i.e., attachment angles) lead to different lowest locations 2nU on the inner surface 2n of the cover 2.

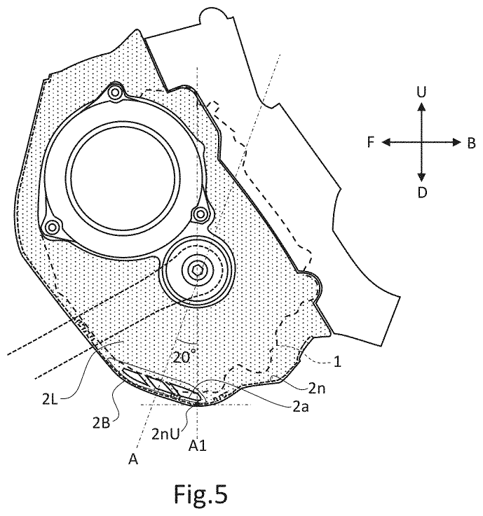

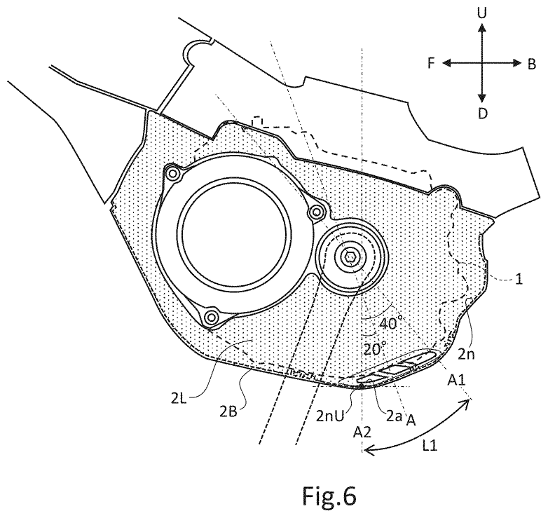

FIGS. 5 and 6 each show a left side view showing an exemplary implementation of the drive unit 10 attached to the vehicle body frame 11 at angles different from that in FIG. 2. The housing 1 of the drive unit 10 shown in FIG. 5 is attached to the vehicle body frame 11 at an angle resulting from a 20° clockwise rotation as viewed from the left about an axis in the left-right direction of the vehicle, starting with the angle of the housing 1 shown in FIG. 2. FIGS. 5 and 6 each show the drive unit 10 as mounted on the vehicle in the upright position.

In the implementation shown in FIG. 5, the lowest location 2nU on the inner surface 2n of the cover 2 is located further toward the rear than in the implementation in FIG. 2. Further, in the implementation in FIG. 5, the top-bottom direction of the drive unit 10 (i.e., cover 2) results from a 20° rotation about an axis in the left-right direction starting with the top-bottom direction of the drive unit in FIG. 2. In the implementation of FIG. 5, too, when the vehicle is in the upright position, as viewed from the left in the left-right direction of the vehicle, the first hole 2a is provided at a location that overlaps an imaginary line extending through the lowest location 2nU on the inner surface 2n of the cover 2 and extending in the top-bottom direction.

In the implementation of FIG. 6, the lowest location 2nU on the inner surface 2n of the cover 2 is located farther toward the front than in the implementation of FIG. 2. Further, in the implementation of FIG. 6, the top-bottom direction of the drive unit 10 (i.e., cover 2) results from a 20° rotation about an axis in the left-right direction starting with the top-bottom direction of the drive unit 10 of FIG. 2. In the implementation of FIG. 6, too, when the vehicle is in the upright position, as viewed from the left in the left-right direction of the vehicle, the first hole 2a is provided at a location that overlaps an imaginary line extending through the lowest location 2nU on the inner surface 2n of the cover 2 and extending in the top-bottom direction.

As shown in FIGS. 2, 5 and 6, any attachment angle of the drive unit 10 (i.e., housing 1) relative to the vehicle body frame 11 may be within a certain range. In such implementations, it is preferable that, when the attachment angle is within the contemplated range, the first hole 2a is located to overlap an imaginary line extending through a region that includes the lowest location 2nU on the inner surface 2n of the cover 2 and extending upward in the top-bottom direction of the vehicle. Thus, the first hole 2a is located above the lowest location 2nU for any attachment angle within the contemplated range. For example, if the contemplated range for the attachment angle is about 40° as shown in FIG. 6, the first hole 2a may be present across region L1 between lines A1 and A2.

It will be understood that changes in the attachment angle in rotation about an axis in the left-right direction of the vehicle does not result in changes in the left-right direction and top-bottom direction in the cross section shown in FIG. 4. The arrangement described with reference to FIG. 4 can be established for any attachment angle within the contemplated range.

As viewed from the right in the left-right direction of the vehicle, the second hole 2b may also be located to overlap an imaginary line extending through a region that includes the lowest location 2nU on the inner surface 2n of the cover 2 and extending upward in the top-bottom direction of the vehicle when the vehicle with the housing 1 mounted thereon is in the upright position.

In every one of the implementations of FIGS. 2, 5 and 6, as viewed from the left in the left-right direction of the vehicle, at least a portion of the first hole 2a is located lower than the housing 1 and does not overlap the housing 1. The edge of the first hole 2a is located below the housing 1 and separated from the housing 1 by an appropriate distance. This enables maintaining an appropriate space between the housing 1 and cover 2 such that water is able to easily exit. Similarly, at least a portion of the second hole 2b may also be located lower than the housing 1 and may not overlap the housing 1 as viewed from the right in the left-right direction of the vehicle.

Referring to FIG. 4, the minimum distance D1 between the housing 1 and the interior edge 2af of the first hole 2a is not limited to any particular value; preferably, the minimum distance is not smaller than 5 mm, and more preferably not smaller than about 10 mm, for example.

In every one of the implementations of FIGS. 2, 5 and 6, the dimension of the first hole 2a in the front-rear direction is larger than the dimension in the top-bottom direction. Shaping a first hole 2a so as to be elongated in the front-rear direction provides a passageway for water over a wide range along the front-rear direction. Thus, the first hole 2a may accommodate a wider range of attachment angles, for example. For the same purpose, the dimension of the second hole 2b in the front-rear direction may be larger than the dimension in the top-bottom direction.

In every one of the implementations of FIGS. 2, 5 and 6, the edge of the first hole 2a as viewed from the left includes lines extending obliquely downward from the front to the rear. Thus, moving air helps water inside the cover to flow so as to be let out along the lines of the first hole 2a. In the present implementation, the first hole 2a is segmented by rods extending obliquely downward from the front toward the rear. The edges of these rods form the lines of the edge of the first hole 2a extending obliquely downward. As shown in FIG. 3, the edge of the second hole 2b as viewed from the right also includes lines extending obliquely downward from the front toward the rear.

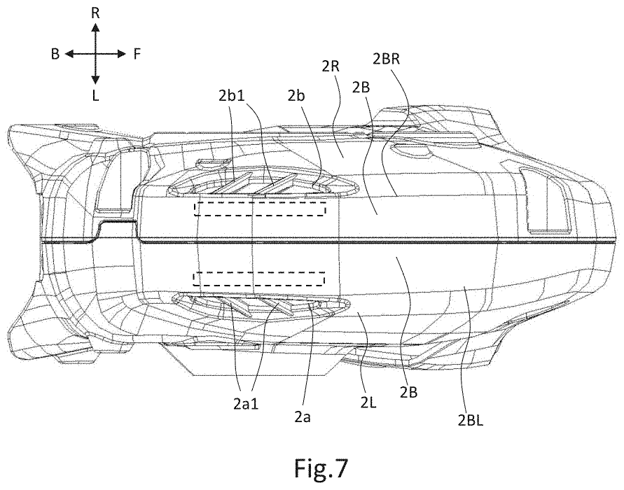

FIG. 7 is a bottom view of the cover 2 of the drive unit 10 shown in FIG. 2. As shown in FIG. 7, the first hole 2a is provided in the left side wall 2L so as to extend to the ridge (i.e., corner) between the bottom portion 2B and left side wall 2L. The second hole 2b is provided in the right side wall 2R so as to extend to the ridge (i.e., corner) between the bottom portion 2B and right side wall 2R. Thus, when the vehicle is tilting to the left or right, water is able to easily exit the bottom portion 2. Alternatively, the first hole 2a may be, for example, located in the bottom portion 2B to the left of the middle of the bottom portion in the left-right direction of the vehicle, as indicated by broken lines in FIG. 7. In such implementations, for example, the first hole 2a in the bottom portion 2B may extend to the ridge between the bottom portion 2B and left side wall 2L. Alternatively, the first hole 2a may be present in both the left side wall 2L and bottom portion 2B. The second hole 2b may also be provided in the bottom portion 2B to the right of the middle in the left-right direction of the vehicle, as indicated by broken lines in FIG. 7, for example. In such implementations, the second hole 2b may extend to the ridge between the bottom portion 2B and right side wall 2R, for example. Alternatively, the second hole 2b may be present in both the right side wall 2R and bottom portion 2B.

In the implementation shown in FIG. 7, the rods 2a1 segmenting the opening of the interior of the first hole 2a extend to become closer to the interior in the left-right direction of the vehicle as the first hole 2a extends from the front toward the rear. The rods 2b1 segmenting the opening of the second hole 2b extend to become closer to the interior in the left-right direction of the vehicle as the second hole 2b extends from the front toward the rear.

The dimension of the first hole 2a in the front-rear direction is larger than the dimension in the left-right direction. The dimension of the second hole 2b in the front-rear direction is larger than the dimension in the left-right direction. The first and second holes 2a and 2b are arranged in the left-right direction of the vehicle and located to be opposite to each other. The bottom portion 2B of the cover 2 is located between the first and second holes 2a and 2b.

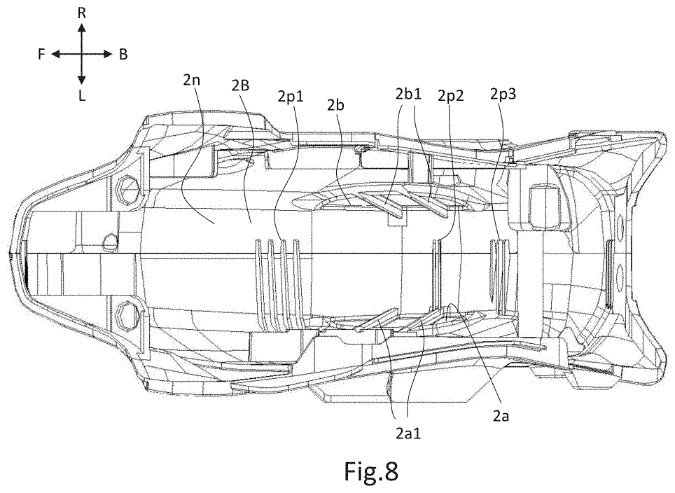

FIG. 8 is a top view of the cover 2 of the drive unit 10 shown in FIG. 2. The bottom portion 2B of the cover 2 is provided with ribs 2p1, 2p2, and 2p3 extending upward from the inner surface 2n. The ribs 2p1, 2p2, and 2p3 extend in the left-right direction of the vehicle. In the left-right direction of the vehicle, the ribs 2p1, 2p2, and 2p3 extend only across a portion of the bottom portion 2B, rather than the entire bottom portion. This prevents the ribs from hampering the flow of water on the bottom portion 2B. The ribs 2p1 are located farther toward the front than the first hole 2a. The ribs 2p2 are provided at locations between corresponding locations of the front and rear ends of the first hole 2a. The ribs 2p3 are located farther toward the rear than the first hole 2a.

In the cover 2 of the drive unit 10 shown in FIG. 4, the interior edge 2af of the first hole 2a is inclined toward the left in the left-right direction of the vehicle when the vehicle is in the upright position. That is, the leftmost point of the edge 2af of the first hole 2a is located higher than the rightmost point. As the first hole 2a is inclined toward the left, water that has flowed from above the first hole 2a along the inner surface 2n of the cover 2 is able to easily drop downward from the edge of the first hole 2a and thus out of the cover 2. Further, in the implementation of FIG. 4, the interior edge 2bf of the second hole 2b is inclined toward the right in the left-right direction of the vehicle. As the second hole 2b is inclined toward the right, water that has flowed from above is able to easily be let out through the second hole 2b.

In the implementation of FIG. 4, the left side wall 2L extends from the edge of the first hole 2a upwardly and outwardly (i.e., to the left) in the left-right direction of the vehicle. In other words, the left side wall 2L extends upward from the first hole 2a to be inclined to the left. Further, the right side wall 2R extends from the edge of the second hole 2b upwardly and outwardly (i.e., to the right). In other words, the right side wall 2R extends upward from the second hole 2b to be inclined to the right. Thus, cover portions located above the first and second holes 2a and 2b are shaped to conform with the shape of the housing 1.

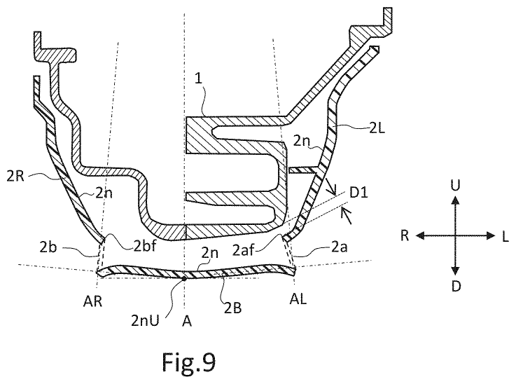

FIG. 9 is a cross-sectional view of a variation of the cover 2 shown in FIG. 4. In the cover 2 shown in FIG. 9, the interior edge 2af of the first hole 2a is inclined to the right in the left-right direction of the vehicle when the vehicle is in the upright position. That is, the lowermost point of the edge 2af of the first hole 2a is located farther toward the left (i.e., outward) than the uppermost point. In this arrangement, water drops and/or mud splashed from below while the vehicle is traveling are less likely to enter the first hole 2a. Further, the interior edge 2bf of the second hole 2b is inclined toward the left in the left-right direction of the vehicle. That is, the lowermost point of the edge 2bf of the second hole 2b is located farther toward the right (i.e., outward) than the uppermost point.

In the implementation shown in FIG. 9, a left end portion of the bottom portion 2B including the left end which is in contact with the first hole 2a is curved obliquely downward toward the left when the vehicle is in the upright position. That is, from the edge of the first hole 2a, the bottom portion 2B is curved to extend upwardly and to the right (i.e., inwardly) in the left-right direction of the vehicle and then extend downwardly. As a left end portion of the bottom portion 2B including the left end in contact with the first hole 2a is curbed obliquely downward to the left, water drops and/or mud from below are better prevented from entering the first hole 2a. Similarly on the right side, a right end portion of the bottom portion 2B including the right end in contact with the second hole 2b is curved obliquely downward to the right when the vehicle is in the upright position. This prevents water drops and/or mud from below from entering the second hole 2b.

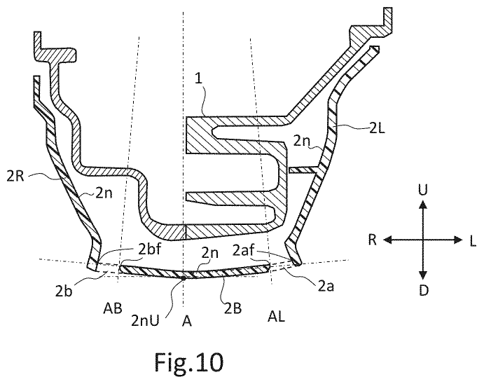

FIG. 10 is a cross-sectional view of another variation of the cover 2 shown in FIG. 4. In the cover 2 shown in FIG. 10, the left side wall 2L extends from the interior edge 2af of the first hole 2a upwardly and to the right (i.e., inwardly) in the left-right direction of the vehicle. In such implementations, the first hole 2a is less visible obliquely from above on the left side. Further, as portions of the left side wall 2L located above the first hole 2a expand outwardly (i.e., to the left) as they extend downward, air inside the cover 2 is able to easily be let out through the first hole 2a. This promotes water to flow out through the first hole 2a. For the same reasons, the right side wall 2R extends from the interior edge 2bf of the second hole 2b upwardly and to the right (i.e., inwardly) in the left-right direction of the vehicle. That is, portions of the right side wall 2R located above the second hole 2b expand outwardly (i.e., to the right) as they extend downward.

Vehicles on which the drive unit can be mounted may be, but are not limited to, vehicles that are inclined toward the left when parked, for example. For example, a vehicle on which the drive unit can be mounted may be a leaning vehicle. A leaning vehicle is a vehicle in which, when the vehicle is turning, the vehicle body is inclined toward the direction of turn. A leaning vehicle is often inclined to the left when parked.

Examples of vehicles on which the drive unit can be mounted include bicycles. Such bicycles include electric motor-assisted bicycles and electric bicycles. Such bicycles are not limited to any particular type; examples of vehicles on which the drive unit can be mounted include mountain bikes, road bicycles, city bicycles, cargo bikes, recumbent bicycles and other types of bicycles. Vehicles on which the drive unit can be mounted are not limited to two-wheel vehicles, and may be vehicles with three or more wheels. Examples of vehicles on which the drive unit can be mounted include LMWs and electric four-wheel vehicles.

The implementations discussed above describe arrangements in which at least a portion of the interior edge of the first hole 2a is at the lowest location on the inner surface 2n of the cover 2 when the vehicle is inclined to the left from the upright position by 5°. Such arrangements are not limited to implementations in which the vehicle is inclined to the left by 5°. In the implementations discussed above, at least a portion of the interior edge of the first hole 2a is at the lowest location on the inner surface 2n of the cover 2 at least when the vehicle is inclined to the left from the upright position by 5° to about 10°. It will be understood that, for example, at least a portion of the interior edge of the first hole 2a may be at the lowest location on the inner surface of the cover at least when the vehicle is inclined from the upright position by about 3° to about 10°.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A drive unit for a vehicle, the drive unit comprising:
a motor;
a housing mountable on the vehicle to hold the motor; and
a cover to cover at least a portion of the housing; wherein
the cover includes a bottom portion to cover at least a portion of a lower surface of the housing, and a left side wall extending from the bottom portion to cover at least a portion of a left side of the housing in a left-right direction of the vehicle;
the cover includes a first hole located in at least one of (a) a location on the bottom portion to the left of a center of the bottom portion in the left-right direction, or (b) the left side wall; and
when the vehicle with the housing mounted thereon tilts to the left from an upright position by 5°, at least a portion of an interior edge of the cover at the first hole is at a lowest location on an inner surface of the cover in a direction of gravity.

2. The drive unit according to claim 1, further comprising a rib on the bottom portion of the cover to extend upward from the inner surface.

3. The drive unit according to claim 1, wherein
the first hole is provided in the left side wall; and
as viewed from the left in the left-right direction, at least a portion of the first hole is located below the housing and does not overlap the housing.

4. The drive unit according to claim 1, wherein
the cover includes a right side wall extending from the bottom portion to cover at least a portion of a right side of the housing in the left-right direction;
the cover includes a second hole provided in at least one of (c) a location on the bottom portion to the right of the center of the bottom portion in the left-right direction, or (d) the right side wall; and
when the vehicle with the housing mounted thereon tilts to the right from the upright position by 5°, at least a portion of an interior edge of the cover at the second hole is at a lowest location on the inner surface of the cover in the direction of gravity.

5. The drive unit according to claim 4, wherein
the first hole is provided in the left side wall;
the second hole is provided in the right side wall; and
as viewed in the left-right direction, at least a portion of the first hole overlaps at least a portion of the second hole.

6. The drive unit according to claim 1, wherein an edge of the first hole as viewed in the left-right direction includes a line extending obliquely downward from a front toward a rear.

7. The drive unit according to claim 1, wherein, when the vehicle with the housing mounted thereon is in the upright position, the interior edge of the cover at the first hole is inclined toward the left in the left-right direction.

8. The drive unit according to claim 1, wherein the left side wall extends from the interior edge of the cover at the first hole upwardly and outwardly in the left-right direction.

9. The drive unit according to claim 1, wherein the left side wall extends from the interior edge of the cover at the first hole upwardly and inwardly in the left-right direction.

10. A cover for a drive unit including a housing mountable on a vehicle to hold a motor, the cover comprising:
a bottom portion to cover at least a portion of a lower surface of the housing;
a left side wall extending from the bottom portion to cover at least a portion of a left side of the housing in a left-right direction of the vehicle; and
a first hole located in at least one of (a) a location on the bottom portion to the left of a center of the bottom portion in the left-right direction, or (b) the left side wall; wherein in a cross section represented by a plane extending in the left-right direction and extending through the first hole, at least a portion of an interior edge of the cover at the first hole is at a lowest location on an inner surface of the cover in a direction of a reference axis extending obliquely downward to the left at an angle of 5° from a top-bottom direction of the vehicle.
